(19) United States
(12) Patent Application Publication
(10) Pub. No.: US 2018/0198277 A1
(43) Pub. Date: Jul. 12, 2018

(54) Methods And Systems For A Renewable Electricity System

(71) Applicants: Damian Antone Bollermann, Castle Valley, UT (US); Adele Alsop, Castle Valley, UT (US)

(72) Inventors: Damian Antone Bollermann, Castle Valley, UT (US); Adele Alsop, Castle Valley, UT (US)

(21) Appl. No.: 15/451,127

(22) Filed: Mar. 6, 2017

Related U.S. Application Data
(63) Continuation-in-part of application No. 15/404,842, filed on Jan. 12, 2017.

(51) Int. Cl. H02J 3/00; H02P 4/00; G06Q 10/06; G06Q 50/06

(52) U.S. Cl. CPC H02J 3/005; G06Q 50/06; G06Q 10/06313; H02P 4/00

(57) ABSTRACT

Disclosed are methods and systems for a renewable electricity system. Connections are provided to a renewable power source, an energy storage unit, and an electric utility grid. Power usage data is aggregated and projected. Draws from the power source, energy storage unit, and the electric utility grid are regulated by a controller.

### CROSS REFERENCE TO RELATED PATENT APPLICATION

This application is a continuation-in-part of, and claims priority to, U.S. patent application Ser. No. 15/404,842 filed Jan. 12, 2017, herein incorporated by reference in its entirety.

### BACKGROUND

Electricity systems powered by renewable energy power sources may mitigate power draw from an electric utility grid. Such renewable energy power sources may include photovoltaic arrays. Although the power draw from the electric utility grid may be mitigated, these renewable energy systems may not minimize or eliminate the draw from the electric utility grid. Thus, users may still experience various disadvantages orf electric utility grid use, including variable pricing times or tiers, and unpredictable connectivity.

### SUMMARY

It is to be understood that both the following general description and the following detailed description are exemplary and explanatory only and are not restrictive. Provided are methods and systems for a renewable electricity system. In common parlance the words energy and power are often used interchangeably. A strict definition of power is a rate of transfer of energy. In this application the word power may be used to describe a source of energy or potential for a flow of energy or a flow of energy, as is common in speech. In this application the words power source may be used to describe a source of electrical energy. Similarly, the words power usage may be used to describe the usage of energy.

In an aspect, an apparatus is disclosed that can comprise a connection to an electric utility grid, at least one power source independent of the electric utility grid, at least one energy storage unit coupled to the at least one power source, and a controller configured to regulate a supply of power to at least one load from the electric utility grid, the art least one power source, and the at least one energy storage unit

In an additional aspect, a method is disclosed that can comprise providing, by at least one power source independent of an electric utility grid, a first power supply; providing, by at least one energy storage unit, a second power supply; providing, by a connection to an electric utility grid, a third power supply; and regulating, by a controller, a flow of one or more of the first power supply, the second power supply and the third power supply between the electric utility grid, the at least one energy storage unit, the at least one power supply, and at least one load.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an example diagram of a renewable electricity system;

FIG. 2 is an example diagram of a renewable electricity system;

FIG. 3 is a flowchart of an example method; and.

FIG. 4 is a block diagram of an example computer.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present disclosure relates to a renewable electricity system. In an aspect, the renewable electricity system can include a renewable power source such as a photovoltaic array or other solar array. The renewable power source can also include other power sources such as wind turbines, hydroelectric turbines, or other renewable power sources as can be appreciated. The renewable electricity system can also include a energy storage unit such as a battery. in such an aspect, the renewable power source and/or the energy storage unit can supply a direct current (DC) flow to an inverter that supplies an alternating current (AC) flow to one or more loads. The renewable electricity system can also include a connection to an electric utility grid supplying an AC flow to the one or more loads. In an aspect, a controller can be communicatively coupled to the renewable electricity system to control a draw of power from the electric utility grid according to various criteria described in more detail below. The controller allows the renewable electricity system to minimize a cost of drawing power from the electric utility grid, thereby minimizing the overall cost to the user. The controller can also maintain various criteria for the energy storage unit, such as a maximum or minimum charge threshold.

In another aspect, a renewable electricity system can include an energy storage unit as described above coupled to a DC converter. The DC converter can boost up or step down the voltage of a DC output from the energy storage unit. The DC output from the DC converter can be supplied to an inverter, which then supplies an AC output to one or more loads. The DC converter can also supply a DC output to an AC/DC load. The AC/DC load can also draw power from an electric utility grid connection. In an aspect, a controller can be communicatively coupled to the renewable electricity system to control a draw of power from the electric utility grid according to various criteria described in more detail below. In such an aspect, as power blending occurs on the DC side, it prevents power output back to the grid, overcoming regulatory challenges and pricings related to power systems which can supply excess power to the grid.

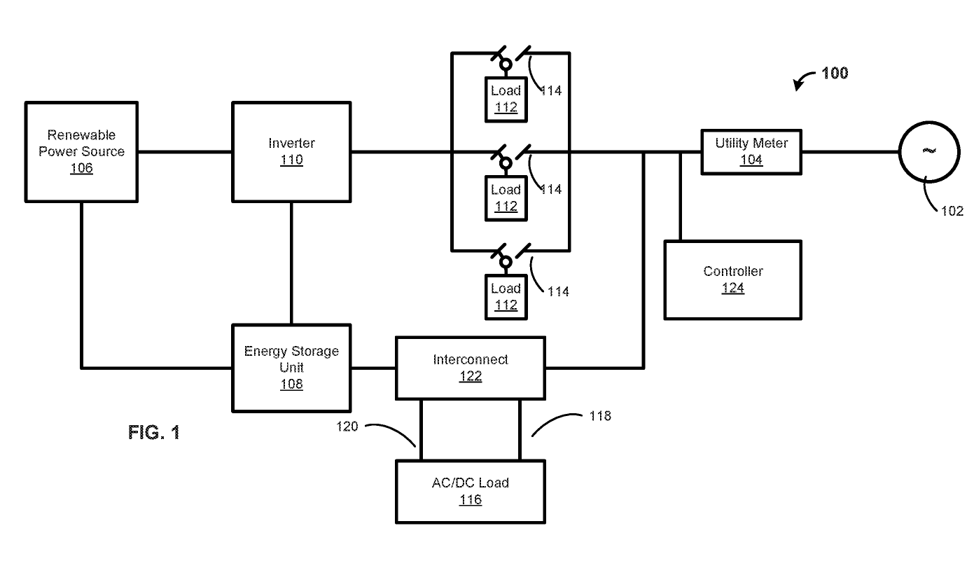

FIG. 1 depicts an example renewable enemy system 100. in an aspect, the renewable electricity system 100 can be connected to an electric utility grid 102 supplying an AC output to the renewable electricity system 100. The electric utility grid 102 can include a public utility grid or other extant utility grid. In an aspect, the electric utility grid 102 can be connected to the renewable electricity system 100 through a utility meter 104 monitoring a power draw from the electric utility grid 102. A renewable power source 106 can also be connected to the renewable electricity system 100. The renewable power source 106 can supply power to the renewable electricity system 100 independent of the electric utility grid 102. In an aspect, the renewable power source 106 can include a photovoltaic array or solar array. In another aspect, the renewable power source 106 can include a hydroelectric turbine, wind turbine, or other renewable power source 106 as can be appreciated. In an aspect, the renewable power source 106 can provide a DC output.

In an aspect, the renewable electricity system 100 can also include an energy storage unit 108, such as a battery. In an aspect, the energy storage unit 108 can receive charge from power output by the renewable power source 106 or the electric utility grid 102. In an aspect, the energy storage unit 108 may be representative of multiple energy storage units 108 operating serially or in parallel. For example, the energy storage unit 108 may include an array or bank of batteries or other storage devices. In an aspect, the renewable power source 106 may provide a DC output to charge the energy storage unit 108. In an aspect, the renewable power source 106 and energy storage unit 108 can each provide a DC output to an inverter 110. The inverter 110 can convert DC inputs received from the renewable power source 106 or energy storage unit 108 into an AC output supplied to one or more loads 112. The inverter 110 may also convert an AC output from the electric utility grid 102 to a DC output to charge the energy storage unit 108.

Each of the one or more loads 112 depicted in FIG. 1 are representative of any number of loads that may draw AC power from the renewable electricity system 100. An AC bus of each of the loads 112 can be connected to a switch 114. Each switch 114 can be operable to switch a source of AC draw by the respective load 112 between the electric utility grid 102 and an AC output of the inverter 110.

In an aspect, the renewable electricity system 100 can also include one or more AC/DC loads 116. An AC/DC load 116 can be a load capable of drawing AC power from an AC bus 118 or a DC bus 120. in an aspect, the AC/DC load 116 can include a variable frequency drive (VM). In another aspect, the AC/DC load 116 can include an inverter, a variable frequency inverter, or another AC/DC load 116 as can be appreciated. In an aspect, the electric utility grid 102 can supply AC power to the AC bus 118 through an interconnect 120, and the energy storage unit 108 supplies DC power to the AC/DC load 116 to the DC bus 120 through the interconnect 122.

In an aspect, the interconnect 122 can include a switch operable to alternate between coupling the AC output of the electric utility grid 102 to the AC bus 118 and coupling DC output of the energy storage unit 108 to the DC bus 120, Thus, the AC/DC load 116 can be supplied alternatively with either AC power from the electric utility grid 102 or DC power from the energy storage unit 108. In another aspect, the interconnect 122 may supply power simultaneously from the electric utility grid 102 and energy storage unit 108 to the AC bus 118 and DC bus 120, respectively. In an aspect, the interconnect 122 can include a DC converter that modifies a voltage of DC output from the energy storage unit 108 prior to supplying the DC bus 120, For example, the DC converter can include a regulator that reduces the voltage of DC output from the energy storage unit 108. This, if the AC/DC load 116 is being charged with capacitors in a zero charge state, the regulator can regulate the voltage supplied to the capacitors to prevent overload or other damage. In another aspect, the DC converter can boost the voltage of DC output from the energy storage unit 108.

In an aspect, the renewable electricity system 100 can also include a controller 124. The controller 124 can include any combination of hardware, software, computing devices, embedded software, or circuitry configured to regulate a source of power draw by the loads 112 and AC/DC load 116, as well as a power draw to charge the energy storage unit 1.08. Thus, the controller 124 can regulate a. draw from the electric utility grid 102, renewable power source 106, and the energy storage unit 108. Although the controller 124 is depicted as being communicatively coupled to an output of the utility meter 104 in the renewable electricity system 100, it is understood that this serves as an exemplary depiction and that the controller 124 may be communicatively coupled to any other component of the renewable electricity system 100, or combinations thereof, in order to perform the disclosed functions.

In an aspect, the controller 124 can aggregate power usage data in order to determine how to regulate the draw from the electric utility grid 102, renewable power source 106, and the energy storage unit 108. In an aspect, the power usage data can include fee schedules, rate schedules—combinations thereof , and the like, indicating a cost of drawing an amount of power from the electric utility grid 102 at a particular time. The power usage data can also include data indicating a power usage of respective loads 112 or of the total loads 112 over time. Additionally, power usage data can indicate an amount of power generated by the renewable power source 106 over time. Power usage data can also include a charge rate or charge level of the energy storage unit 108. In an aspect, the power usage data can be aggregated from sensors in communication with the respective components of the renewable electricity system 100. in a further aspect, the power usage data can be received from a server or other computing device.

In an aspect, power usage data can be stored by the controller 124, a server, or other computing device in a database or other data structure. The power usage data can be stored in encrypted or unencrypted form, The controller 124 can be in communication with such a server or computing device by a wired or wireless connection. Additionally, the controller 124 can be configured or otherwise controlled by a mobile device or other user device.

In an aspect, the controller 124 can selectively combine a draw from the renewable power source 106, energy storage unit 108, and electric utility grid 102 according to user-defined or default thresholds. For example, a hard threshold can be established above which no power is drawn from the electric utility grid 102, but can have a second threshold where power is drawn from the electric utility grid 102 and from the renewable power source 106 and/or energy storage unit 108 at the same time. Additionally, in aspects where multiple renewable power sources 106 are installed in the same renewable electricity system 100, the controller 124 can select one or a combination of renewable power sources 106 for draw.

In an aspect, the controller 124 can also aggregate contextual data for correlation with the power usage data and to assist in generating projected power usage data as will be described below. The contextual data can describe operating circumstances of the renewable electricity system 100 at a given time. In an aspect, contextual data can include weather information, time and date information, other data correlated with respective power usage data points, combinations thereof and the like.

The controller 124 can also generate projected power usage data from the aggregated power usage data. For example, the controller 124 can predict projected power usage by loads 112 over time using the aggregated power usage data for the loads 112. As another example, the controller 124 can project power generation for the renewable power source 106. In an aspect, this can be performed by correlating past instances of power generation by the renewable power source 106 with weather information indicated in the contextual data, and then generating a projected power generation based on forecasted weather conditions. Projected power usage data can also include projected costs based on a correlation between projected power usage and known or predicted pricing tiers or schemes.

Using the aggregated and generated power usage data, the controller 124 can regulate a draw to minimize an amount of power or a cost of power drawn from the electric utility grid 102. For example, the controller 124 can determine to draw power for a load 112 or AC/DC load 116 from the energy storage unit 108 during a time of increased or peak price periods from the electric utility grid 102. In an aspect, this can include generating a cost forecast based on rate information, projected load 112 draws, projected charge levels in the energy storage unit 108, or other data. In another aspect, a user defined price threshold can set an actual or estimated cost threshold for drawing power from the electric utility grid 102. When an actual or estimated usage cost of drawing power from the electric utility grid 102 has been met, the controller will refrain from selecting the electric utility grid 102 for draw. In an aspect, power can continue to be drawn from the electric utility grid 102 above the cost threshold when one or more conditions are met, such as a charge of the energy storage unit 1.08 or a supply from the renewable power source 1.06 falling below a threshold. Such a threshold can be calculated as a function of a number of concurrent or projected draws from the loads 112.

In an aspect, the controller 124 can regulate a flow of power in the renewable electricity system 100 according to a threshold charge rate and/or threshold charge level of the energy storage unit 108. For example, power generated by the renewable power source 106 in excess of a current draw can be preferentially diverted to the energy storage unit 1.08 until a threshold charge rate or threshold charge level is reached. In an aspect, the controller 124 can divert power from the renewable power source 106 back to the electric utility grid 102 when the threshold charge rate or threshold charge level of the energy storage unit 108 is reached. In an aspect, the controller 124 can also output a stored charge in the energy storage unit 108 to the electric utility grid 102 based on projected power generation by the renewable power source 106, projected draws from the loads 112, a current charge level with respect to a threshold charge level, or other data. In a further aspect, the controller 124 can regulate a draw from the loads 112 or AC/DC load 116 from the energy storage unit 108 independent of a minimum charge threshold responsive to an outage in the electric utility grid 102, an increased or peak price period, or other criteria.

Advantages of the renewable energy system 100 are apparent. For example, the renewable energy system 100 has advantages over systems where an AC/DC load 116 is supplied by an inverter 110 at its AC bus 118. Such an arrangement would require DC power to be converted to AC, then back to DC. In contrast, the renewable energy system 100 is more efficient as it allows supply of DC power to the DC bus 120 without redundant conversion. Additionally, the renewable energy system 100 can potentially require smaller total inverter 110 capacity since some loads 112 or AC/DC loads 116 can be supplied without the need for power flows through an inverter 110.

Arrangements including VFDs as AC/DC loads 116 can also exhibit unwanted harmonics on the AC line. Such harmonics can cause problems including component overheating, component failure, or line interference. The arrangement set forth in the renewable energy system 100 reduces this issue by regulating a DC supply from the energy storage unit 108 via the interconnect 122, which can include a DC converter. Thus, the DC supply to the DC bus 120 of AC/DC loads 116 is deliverable at a voltage acceptable to the requirements of the AC/DC loads 116. Furthermore, regulation of the delivered DC voltage relative to the output DC voltage of the AC to DC converter comprising a component of the AC/DC load provides an effective means for regulating power flows from both the AC and DC sources to the AC/DC loads 116.

The renewable energy system 100 includes additional advantages over systems where power supplies are switched essentially entirely from an “off grid” system, such as the renewable power source 106 and/or the energy storage unit 108, to “on grid,” such as an electric utility grid 102. Such a switching system has a disadvantage in that the total load transferred includes the sum of total loads 112 (and/or AC/DC loads 116) transferred. Accordingly, the amount of power transferred between “off grid” and “on grid” systems must be incremented by a value corresponding to the total onsite load presented by the one or more of the loads H2 or AC/DC loads 116 so transferred. In contrast, the renewable energy system 100 allows for transfer of individual loads or for the transfer of both fractional and total requirements of AC/DC loads 116 to be supplied from either on grid” or “off grid” sources. Thus, the renewable energy system 100 allows for reduced harmonic interference as well as blending between AC and DC (or “on grid” and “off grid”) power supply to AC/DC loads 116. with such blending occurring by any defined fraction or balance between AC and DC (or “on grid” and “off grid”) sources.

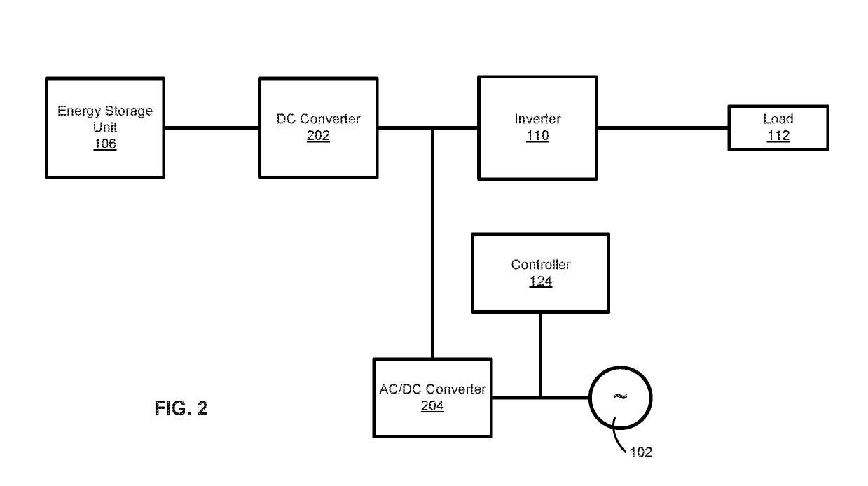

FIG. 2 depicts another example renewable electricity system 200. The renewable electricity system 200 can comprise, for example, an electric utility grid 102 connection, an energy storage unit 106, inverter 110, and controller 124, which can operate as described above with respect to FIG. 1. As was set forth in FIG, 1, although the controller 124 is depicted as being communicatively coupled to a connection to the electric utility grid 102, it is understood that this serves as an exemplary depiction and that the controller 124 may be communicatively coupled to any other component of the renewable electricity system 200, or combinations thereof, in order to perform the disclosed functions, Also included in the renewable electricity system 200 is a load 112 connected to an AC output of the inverter 110, which can be representative of any number of loads 112.

In an aspect, the DC output of an energy storage unit 106 is provided to a DC converter 202. The DC converter 202 is operable to modify a voltage of the DC power supplied by the energy storage unit 106. For example, the DC converter 202 can reduce or step down the voltage supplied by the energy storage unit 106. The reduced voltage DC output can then be supplied to the inverter 110. The inverter 110 can also be provided a DC output from an AC/DC converter 204, which converts an AC input from the electric utility grid 102 into a DC output. By implementing a duel-fed inverter 110 accepting DC voltage from both the energy storage unit 106 via the DC converter 202 and the electric utility grid 102 via the AC/DC converter 204, a controller can regulate an overall DC input to the inverter 110. This is distinct from conventional approaches that may instead regulate the AC output of the inverter 110 to control power blending, or approaches where the electric utility grid 102 is on the AC side of the inverter 110. By performing power blending on the DC side of the inverter 110, it becomes impossible to export excess power back to the electric utility grid 102. This provides advantages in regulatory environments where power systems capable of exporting power to an electric utility grid 102 are subject to additional costs or delays in construction. An ability to export power to an electric utility grid may also be provided while simultaneously providing other advantages of the disclosed systems and methods.

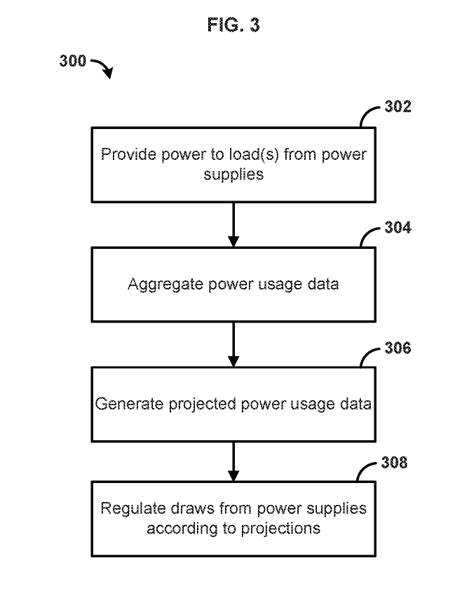

FIG. 3 is a flowchart depicting an example method 300. Beginning with step 302, a renewable electricity system 100 can provide power to one or more loads 112 from power supplies. Power can also be provided to one or more AC/DC loads 116. The power supplies can include a connection to an electric utility grid 102, a renewable power source 106, an energy storage unit 108, or a combination thereof

In step 304, a controller 124 can aggregate power usage data from the renewable electricity system 100. In an aspect, the power usage data aggregated can indicate load draws 112 over time, energy storage unit 108 charge rates or charge levels over time, power generation rates for the renewable power source 106, draw rates from the electric utility grid 102, or other usage data as can be appreciated, or combinations thereof. In an aspect, the power usage data can also include price and/or rates for drawing power from the electric utility grid 102. The power usage data can be aggregated from sensors coupled to the respective components of the renewable electricity system 100 and in communication with the controller 124. The power usage data can also be aggregated from a server or other computing device in communication with the respective components of the renewable electricity system 100.

In step 306 the controller 124 can generate projected power usage data from the aggregated power usage data. In an aspect, this can include generating projection models for load 112 draws, electric utility grid 102 draws, power generation by the renewable power source 106. price periods, or other projections. In an aspect, the controller 124 can correlate instances of the aggregated power usage data with corresponding contextual data including weather forecasts, date, and time information. For example, the controller 124 can correlate samples of power generation by the renewable power source 106 or samples of load 112 draws with the corresponding weather, date, and time in order to generate projections based on weather forecasts.

Next, in step 308 the controller 124 can regulate the draws of loads 112 or AC/DC loads 116 from the respective power sources based on the projections. For example, if a projected draw by the loads 112 or AC/DC loads 116 exceeds a projected power generation by the renewable power source 106 during a peak price period, the controller 124 may determine a minimum charge threshold for the energy storage unit 108 to supply the excess draw. In an aspect, the controller 124 can determine to draw power from the electric utility grid 102 during a minimum price period in order to maintain a charge rage for the energy storage unit 108. In another aspect, the controller 124 can regulate the overall draws from the power supplies in order to minimize an overall cost or draw from the electric utility grid 102.

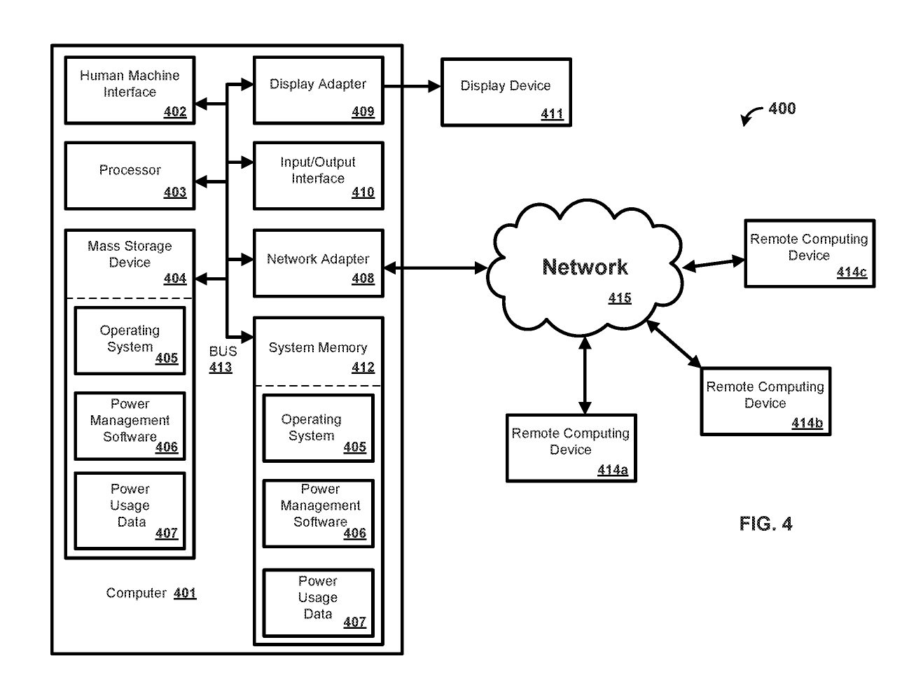

In an exemplary aspect, the methods and systems can be implemented on a computer 401 as illustrated in FIG. 4 and described below. By way of example, controller 124 of FIG. 1 can be a computer as illustrated in FIG. 4. Similarly, the methods and systems disclosed can utilize one or more computers to perform one or more functions in one or more locations. FIG. 4 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 401. The components of the computer 401 can comprise, but are not limited to, one or more processors 403, a system memory 412, and a system bus 413 that couples various system components including the one or more processors 403 to the system memory 412. The system can utilize parallel computing.

The system bus 413 represents one or more of several possible types of bus structures, including a memory bus or memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 413, and all buses specified in this description can also be implemented over a wired or wireless network connection and each of the subsystems, including the one or more processors 403, a mass storage device 404, an operating system 405, power management software 406, power usage data 407, a network adapter 408, the system memory 412, an Input/Output Interface 410, a display adapter 409, a display device 411, and a human machine interface 402, can be contained within one or more remote computing devices 414a,b,c at physically separate locations, connected through buses of this form, in effect implementing a fully distributed system.

The computer 401 typically comprises a variety of computer readable media. Exemplary readable media can be any available media that is accessible by the computer 401 and comprises, for example and not meant to be limiting, both volatile and non-volatile media, removable and non-removable media. The system memory 412 comprises computer readable media in the form of volatile memory, such as random access memory (RAM), and/or non-volatile memory, such as read only memory (ROM). The system memory 412 typically contains data such as the power usage data 407 and/or program modules such as the operating system 405 and the power management software 406 that are immediately accessible to and/or are presently operated on by the one or more processors 403.

In another aspect, the computer 401 can also comprise other removable/non-removable, volatile/non-volatile computer storage media. By way of example, FIG. 4 illustrates the mass storage device 404 which can provide non-volatile storage of computer code, computer readable instructions, data structures, program modules, and other data for the computer 401. For example and not meant to be limiting, the mass storage device 404 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 404, including by way of example, the operating system 405 and the power management software 406. Each of the operating system 405 and the power management software 406 (or some combination thereof) can comprise elements of the programming and the power management software 406. The power usage data 407 can also be stored on the mass storage device 404. The power usage data 407 can be stored in any of one or more databases known in the art. Examples of such databases comprise, DB2®, Microsoft®Access, Microsoft® SQL Server, Oracle®, PostgreSQL, and the like. The databases can be centralized or distributed across multiple systems.

In another aspect, the user can enter commands and information into the computer 401 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the one or more processors 403 via the human machine interface 402 that is coupled to the system bus 413, but can be connected by other interface and bus structures, such as a parallel port, game port, an IEEE 1394 Port (also known as a Firewire port), a serial port, or a universal serial bus (USB).

In yet another aspect, the display device 411 can also be connected to the system bus 413 via an interface, such as the display adapter 409. It is contemplated that the computer 401 can have more than one display adapter 409 and the computer 401 can have more than one display device 411. For example, the display device 411 can be a monitor, an LCD (Liquid Crystal Display), or a projector. In addition to the display device 411, other output peripheral devices can comprise components such as speakers (not shown) and a printer (not shown) which can be connected to the computer 401 via the Input/Output Interface 410. Any step and/or result of the methods can be output in any form to an output device. Such output can be any form of visual representation, including, but not limited to, textual, graphical, animation, audio, tactile, and the like. The display device 411 and computer 401 can be part of one device, or separate devices.

The computer 401 can operate in a networked environment using logical connections to one or more remote computing devices 414a,b,c. By way of example, a remote computing device can be a personal computer, portable computer, smartphone, a server, a router, a network computer, a peer device or other common network node, and so on. Logical connections between the computer 401 and a remote computing device 414a,b,c can be made via a network 415, such as a local area network (LAN) and/or a general wide area network (WAN). Such network connections can be through the network adapter 408. The network adapter 408 can be implemented in both wired and wireless environments. Such networking environments are conventional and commonplace in dwellings, offices, enterprise-wide computer networks, intranets, and the Internet.

For purposes of illustration, application programs and other executable program components such as the operating system 405 are illustrated herein as discrete blocks, although it is recognized that such programs and components reside at various times in different storage components of the computing device 401, and are executed by the one or more processors 403 of the computer. An implementation of the power management software 406 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DV D) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g., genetic algorithms), swarm intelligence (e.g. ant algorithms), and hybrid intelligent systems (e.g. Expert inference rules generated through a neural network or production rules from statistical learning).

While the methods and systems have been described in connection with preferred ernbodirnents and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. An apparatus, comprising:
a connection to an electric utility grid;
at least one power source independent of the electric utility grid;
at least one energy storage unit coupled to the at least one power source; and
a controller configured to regulate a supply of power to at least one load from the electric utility grid, the at least one power source, and the at least one energy storage unit.

2. The apparatus of claim 1, wherein the at least one second source and the at least one energy storage unit supply a direct current, and the connection to the electric utility grid provides an alternating current.

3. The apparatus of claim 2, further comprising an inverter coupled to the at least one power source and the at least one energy storage unit.

4. The apparatus of claim 1, wherein the at least one energy storage unit is further coupled to the connection to the electric utility grid.

5. The apparatus of claim 1, wherein the at least one load comprises a variable frequency motor load, and the controller is configured to switch a draw of the variable frequency motor load between a direct current from the at least one energy storage unit and an alternating current from the connection to the electric utility grid.

6. The apparatus of claim 1, wherein the controller is configured to regulate a. draw from the connection to the electric utility grid based on pricing data associated with the electric utility grid.

7. The apparatus of claim 6, wherein regulating the draw from the connection to the electric utility grid based on the pricing data associated with the electric utility grid comprises preferentially drawing from the at least one energy storage unit instead of the connection to the electric utility grid to supply the at least one load during a period associated with a peak price.

8. The apparatus of claim 1, wherein the controller is configured to regulate a draw from the at least one energy storage unit based on a minimum charge level of the at least one energy storage unit.

9. The apparatus of claim 1, wherein the controller is configured to preferentially supply power in excess of a draw by the at least one load to the at least one energy storage unit instead of the electric utility grid.

10. The apparatus of claim 1, wherein the at least one power source independent of the electric utility grid comprises a photovoltaic array.

11. A method comprising:
providing, by at least one power source independent of an electric utility grid, a first power supply;
providing, by at least one energy storage unit, a second power supply;
providing, by a connection to an electric utility grid, a third power supply; and
regulating, by a controller, a flow of one or more of the first power supply, the second power supply and the third power supply between the electric utility grid, the at least one energy storage unit, the at least one power supply, and at least one load.

12. The method of claim 11, wherein the at least one power source independent of the electric utility grid comprises a photovoltaic array.

13. The method of claim 11, further comprising:
determining one or more peak price periods associated with the electric utility grid; and
providing, by the controller, power to the at least one load preferentially from the at least one energy storage unit instead of the electric utility grid during the one or more peak price periods.

14. The method of claim 13, wherein the power provided from the at least one energy storage unit corresponds to a difference between power provided by the at least one power source and a power requirement of the at least one load.

15. The method of claim 13, further comprising providing power to the at least one load from the electric utility grid during the one or more peak price periods responsive to a charge level of the at least one energy storage unit falling below a predefined threshold.

16. The method of claim 11, further comprising:
determining one or more reduced price periods associated with the electric utility grid; and
providing, by the controller, power to the at least one load preferentially from the electric utility grid instead of the at least one energy storage during the one or more reduced price periods.

17. The method of claim 16, wherein the power provided from the electric utility grid corresponds to a difference between power provided by the at least one power source and a power requirement of the at least one load.

18. The method of claim 16, further comprising regulating, by the controller, a flow of power to the at least one energy storage unit to maintain a minimum charge level for the at least one energy storage unit while the connection to the electric utility grid provides the third power supply.

19. The method of claim 16, further comprising providing, by the controller, power from the at least one storage unit independent of the minimum charge level responsive to an outage in the connection to the electric utility grid.

20. The method of claim 11, wherein the at least one load comprises a variable frequency motor load, and the method further comprises switching, by the controller, a draw of the variable frequency motor load between a direct current from the at least one energy storage unit and an alternating current from the connection to the electric utility grid.
